(19) United States
(12) Patent Application Publication
(10) Pub. No.: US 2008/0137502 A1
(43) Pub. Date: Jun. 12, 2008

(54) OPTICAL DISC APPARATUS AND OPTICAL DISC RECORDING AND REPRODUCING METHOD

(75) Inventors: Kazumi SUGIYAMA, Kawasaki-shi (JP); Nobuyuki BABA, Kawasaki-shi (JP); Hiroshi NAKANE, Fukaya-shi (JP); Yoshinori TAZAKI, Yokohama-shi (JP); Satoshi SHIBATA, Tokyo (JP)

Correspondence Address: PILLSBURY WINTHROP SHAW PITTMAN, LLP, P.O. BOX 10500, MCLEAN, VA, 22102, US

(73) Assignee: KAUSHIKI KAISHA TOSHIBA, Tokyo (JP)

(21) Appl. No.: 11/925,253

(22) Filed: Oct. 26, 2007

(30) Foreign Application Priority Data
Dec. 7, 2006 (JP) 2006330772

(51) Int. Cl. G11B 15/62

(52) U.S. Cl. 369/53.19

(57) ABSTRACT

According to one embodiment, an optical disc apparatus includes a calculation unit that calculates a tilt of a disc, a determining unit that determines whether or not the tilt of the disc calculated by the calculation unit is larger than a preset predetermined reference value, and a correction unit that corrects the tilt of the disc calculated by the calculation unit.

### CROSS-REFERENCE TO RELATED APPLICATIONS

This application is based upon and claims the benefit of priority from Japanese Patent Application No. 2006-330772, filed Dec. 7, 2006, the entire contents of which are incorporated herein by reference.

### BACKGROUND

1. Field

One embodiment of the invention relates to an optical disc apparatus and an optical disc recording and reproducing method. More particularly, it relates to an optical disc apparatus and an optical disc recording and reproducing method configured so as to be capable of correcting the tilt of a disc.

2. Description of the Related Art

For optical discs typified by a DVD (Digital Versatile Disc)-R and a DVD-ROM, in recent years, a higher density has been pursued. However, with the trend for a higher density, the tilt of the disc has come to largely affect the recording processing or the reproducing processing.

Under such circumstances, there has been proposed a technique for correcting the tilt occurring in the disc during the initial operation. It is disclosed by, for example, JP-A-2000-357338.

In accordance with the technique proposed in JP-A-2000-357338, by detecting the amount of deviation between the reference position which is the position of an objective lens detected when the objective lens has been focused on a reference disc and the position of the objective lens detected when the objective lens has been focused on an optical disc to be reproduced, it is possible to calculate the tilt correction amount based on the detected deviation amount. As a result of this, it is possible to detect the tilt amount without providing an exclusive sensor.

However, with the technique proposed in JP-A-2000-357338, it is possible to calculate the tilt amount without providing an exclusive sensor, and to correct the tilt of the disc based on the calculated tilt amount. However, originally, there is an inherent tilt margin range not presenting a large problem on the recording processing or the reproducing processing even when the tilt occurring in each disc is not corrected for every type (e.g., CD (Compact Disc), DVD, or HD (High Definition)-DVD) of the disc. In spite of this fact, in accordance with this technique, the tilt of every disc is corrected regardless of the magnitude of the tilt occurring in the disc. For this reason, when the tilt of the disc is a small tilt within the tilt margin range, the tilt correction processing is unnecessarily executed. As a result, unfavorably, the initial operation completion time until the completion of the initial operation uselessly increases.

For an optical disc apparatus adaptable to a plurality of types of discs, the reduction of the initial operation completion time has been demanded. However, when the tilt of the disc is a small tilt within the tilt margin range, and the initial operation completion time uselessly increases, a user must wait for a longer time during the period until the completion of the initial operation, and feels uncomfortable.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram for showing a configuration of an inside of an optical disc apparatus according to one embodiment;

FIG. 2 is a flowchart for illustrating a tilt correction processing in the optical disc apparatus of FIG. 1; and

FIG. 3 is an explanatory diagram for illustrating a calculation method of the tilt of an optical disc.

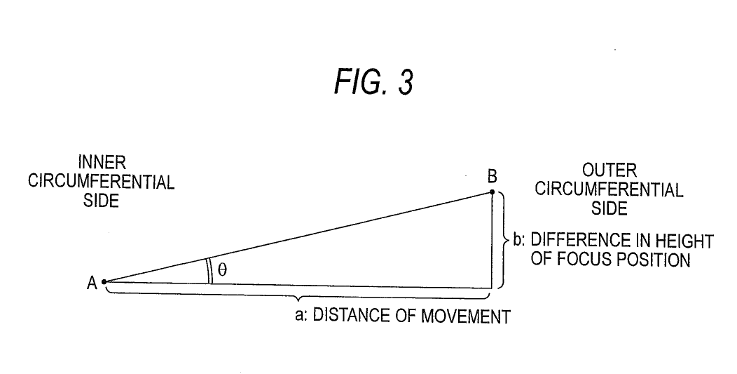

### DETAILED DESCRIPTION

Various embodiments according to the invention will be described hereinafter with reference to the accompanying drawings. In general, according to one embodiment of the invention, an optical disc apparatus includes a calculation unit that calculates a tilt of a disc, a determining unit that determines whether or not the tilt of the disc calculated by the calculation unit is larger than a preset predetermined reference value, and a correction unit that corrects the tilt of the disc calculated by the calculation unit. Further, according to another embodiment of the invention, an optical disc recording and reproducing method of an optical disc apparatus, includes calculating a tilt of a disc, determining whether or not the tilt of the disc is larger than a preset predetermined reference value, and correcting the tilt of the disc.

Below, embodiments of the present invention will be described by reference to the accompanying drawings.

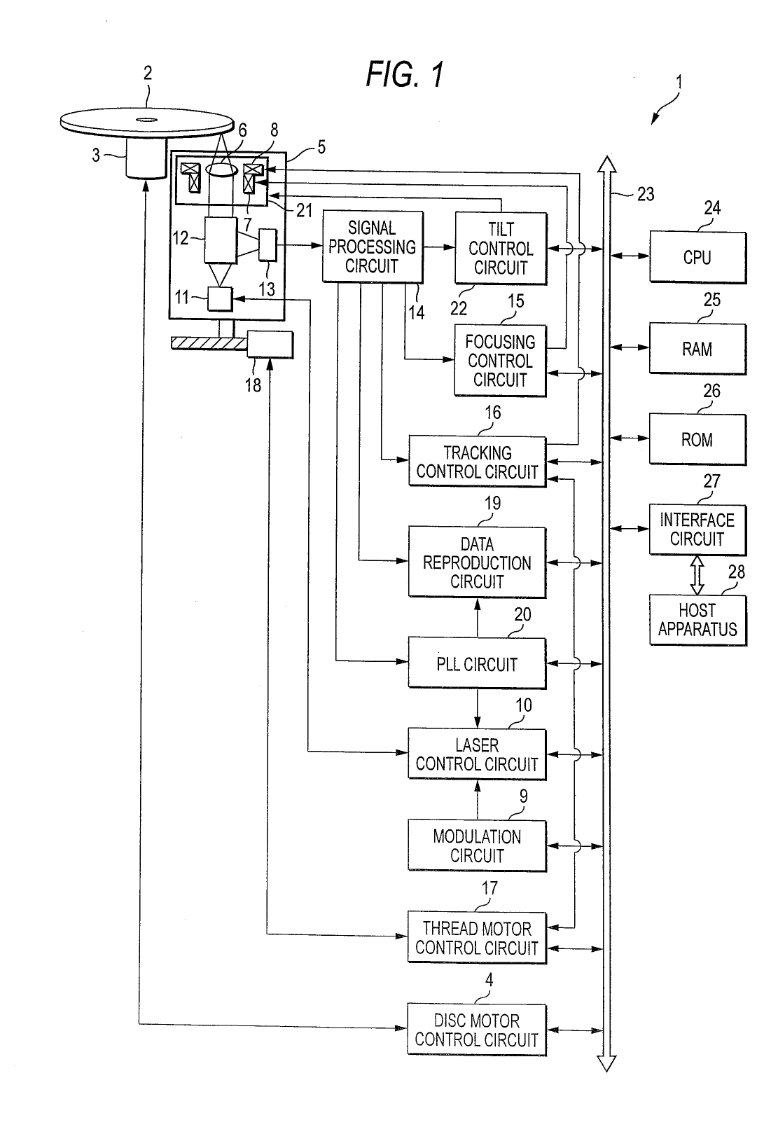

FIG. 1 shows the configuration of the inside of an optical disc apparatus 1 in accordance with the invention. An optical disc 2 is, for example, a read-only optical disc such as a DVD-ROM, or a recording medium capable of recording user data such as a DVD-R or a DVD-RAM. The optical disc 2 is rotationally driven by a disc motor 3. The disc motor 3 is controlled by a disc motor control circuit 4.

Recording and reproducing of information on the optical disc 2 are carried out by an optical pick-up 5. The optical pick-up 5 is provided with an objective lens 6 movably supported by a wire or a blade spring not shown. The objective lens 6 is movable in the focusing direction (the optical axis direction of the lens) by driving of a focus direction driving coil 7. Further, it is movable in the tracking direction (the direction orthogonal to the optical axis of the lens) by driving of a track direction driving coil 8.

A modulation circuit 9 modulates the user data supplied via an interface circuit 27 from a host apparatus 28, and supplies the modulated recording data to a laser control circuit 10. The modulation systems are, for example, 8-16 modulation for the DVD type, and EFM modulation for the CD type. The laser control circuit 10 supplies a write signal to a semiconductor laser diode 11 in the optical pick-up 5 based on the modulated recording data supplied from the modulation circuit 9 for information recording (for mark formation) on the optical disc 2.

The semiconductor laser diode 11 generates a laser light in response to a signal supplied from the laser control circuit 10. The laser light generated from the semiconductor laser diode 11 is applied onto the recording or reproducing side of the optical disc 2 via an optical system component 12 and the objective lens 6. The reflected light from the optical disc 2 passes through the objective lens 6 and the optical system component 12, and is guided to a photodetector 13 in the optical pick-up 5. An output signal from the photodetector 13 is supplied to a signal processing circuit 14.

The signal processing circuit 14 generates a focus error signal (FE signal), and outputs the generated focus error signal (FE signal) to a focusing control circuit 15. The focusing control circuit 15 generates a focusing control signal based on the focus error signal (FE signal) inputted from the signal processing circuit 14, and supplies the generated focusing control signal to the focus direction driving coil 7 of the optical pick-up 5. As a result of this, the objective lens 10 is controlled so that the laser light is normally just focused on the information recording side of the optical disc 2. Whereas, the signal processing circuit 14 generates a tracking error signal (TE signal), and outputs the generated tracking error signal (TE signal) to a tracking control circuit 16. The tracking control circuit 16 generates a tracking control signal based on the tracking error signal inputted from the signal processing circuit 14, and supplies the generated tracking control signal to the track direction driving coil 8 of the optical pick-up 5. As a result of this, the objective lens 6 is controlled so that the laser light follows the track on the information recording side of the optical disc 2.

A signal from the tracking control circuit 16 is supplied to a thread motor control circuit 17. When the objective lens 6 is controlled by the tracking control circuit 16, a thread motor 18 is controlled by the tread motor control circuit 17 so that the objective lens 6 is positioned in the vicinity of the center position in the optical pick-up 5. As a result of this, the movement in the direction of radius of the optical disk 2 of the optical pick-up 5 is controlled.

The signal processing circuit 14 generates a data reproduction signal (RF signal) from the output signal from the photodetector 13, and outputs the generated data reproduction signal (RF signal) to a data reproduction circuit 19. The data reproduction circuit 19 demodulates the recording data using the data reproduction signal (RF signal) inputted from the signal processing circuit 14 based on a reproduction clock signal from a PLL circuit 20. The reproduction data demodulated at the data reproduction circuit 19 is subjected to error correction at an error correction circuit not shown using the accompanying error correction code, and then, it is outputted to the host apparatus 28 via the interface circuit 27. The signal processing circuit 14 has a function as a signal processing unit.

Herein, when the information recording side of the optical disc 2 is tilted with respect to the optical axis of the laser light passing through the objective lens 6 of the optical pick-up 5 due to warp or surface vibration of the optical disc 2, the wave front aberration of the laser light increases. Thus, the magnitude of the data reproduction signal (RF signal) or the focus error signal (FE signal) generated at the signal processing circuit 14 based on the output signal from the photodetector 13 is reduced. As a result, noise increases relatively, resulting in an increase in jitter (the ratio of deviation from the regeneration clock when the data reproduction signal has been made into a binary form). Under such circumstances, in order to avoid such an increase in noise, and the like, a tilt mechanism 21 for adjusting the tilt of the objective lens 6 is provided. The tilt mechanism 21 is mounted at a prescribed position of the optical pick-up 5.

The tilt control circuit 22 controls the tilt mechanism 21 according to the magnitude of a RF signal obtained from the signal processing circuit 14, and tilts the optical axis of the objective lens to an appropriate value relative to the tilt of the information recording side of the optical disc 2.

The disc motor control circuit 4, the thread motor control circuit 17, the modulation circuit 9, the laser control circuit 10, the focusing control circuit 15, the tracking control circuit 16, the data reproduction circuit 10, the PLL circuit 20, the tilt control circuit 22, and the like can be configured in one LSI chip as a servo control circuit. Whereas, these circuits are controlled by a CPU (Central Processing Unit) via a bus 23.

The CPU 24 follows an operation command supplied from the host apparatus 28 via the interface circuit 27, and executes various processings in accordance with the program stored in a ROM (Read Only Memory) 26, and the program loaded from the ROM 26 to a RAM (Random Access Memory) 25. Thus, the CPU 24 generates various control signals, and supplies them to respective parts, and thereby controls the optical disc apparatus 1 in a centralized manner.

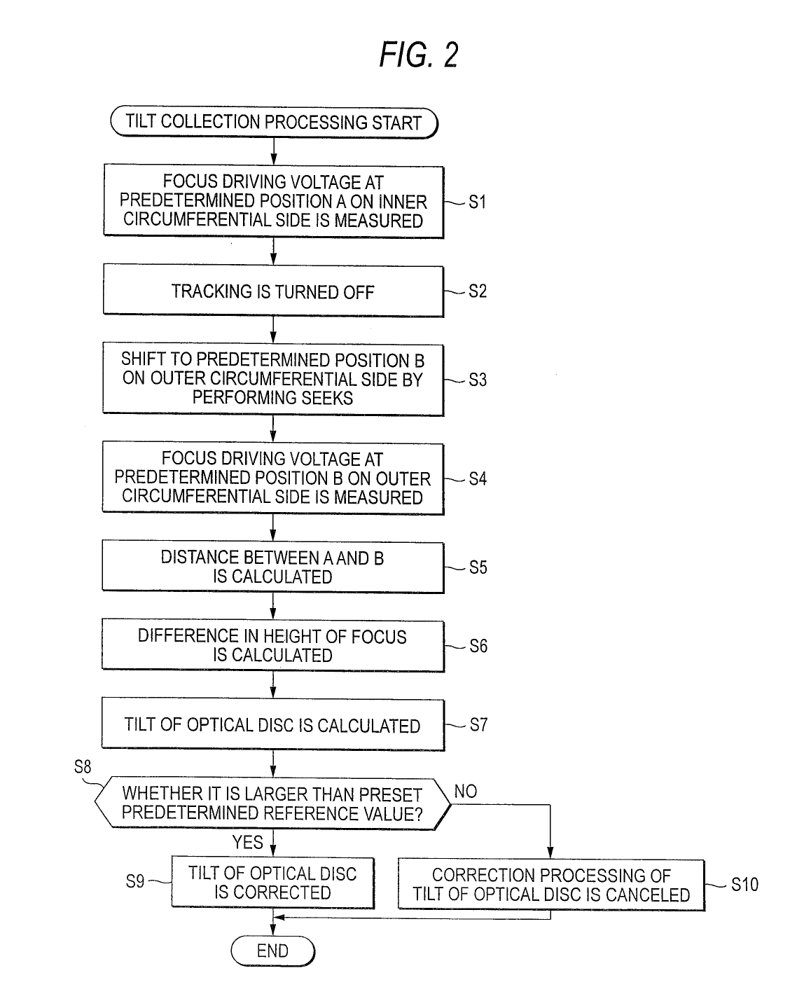

Then, by reference to the flowchart of FIG. 2, the tilt correction processing in the optical disc apparatus 1 of FIG. 1 will be described. The tilt correction processing is initiated after the completion of the initial operation to be executed before the recording processing or the reproducing processing in the optical disc apparatus 1.

In a step S1, the CPU 24 controls the optical pick-up 5, the signal processing circuit 14, and the focusing control circuit 15, and performs focus servo at a preset predetermined position A on the inner circumferential side (e.g., the innermost circumferential position of the inner circumferential side). Then, the inner circumferential side focus driving voltage at that step is measured, and the measured inner circumferential side focus driving voltage is temporarily stored in the RAM 25.

In a step S2, the CPU 24 controls the tracking control circuit 16, and turns off the tracking servo in the optical disc 2.

In a step S3, the CPU 24 controls the optical pick-up 5, the signal processing circuit 14, the tracking control circuit 16, the thread motor control circuit 17, and the like. Thus, it performs seeks in the direction of radius of the optical disc 2 to shift the position of the beam spot (radius position) to a preset predetermined position B on the outer circumferential side (e.g., the outermost circumferential position of the outer circumferential side).

In a step S4, the CPU 24 controls the optical pick-up 5, the signal processing circuit 14, and the focusing control circuit 15, and performs focus servo at a preset predetermined position B on the outer circumferential side (e.g., the outermost circumferential position of the outer circumferential side). Then, the outer circumferential side focus driving voltage at that step is measured, and the measured outer circumferential side focus driving voltage is temporarily stored in the RAM 25.

In the step 5, the CPU 24 calculates the distance (distance of movement) a between the two points (i.e., the preset predetermined position A on the inner circumferential side and the preset predetermined position B on the outer circumferential side) at which the focus driving voltages were measured by using following expression:

a=Thread motor step movement sensitivity (μm/step)×number of steps between A and B (steps).

In a step S6, the CPU 24 calculates the difference b in height of the focus position between at A and B based on the inner circumferential side focus driving voltage (the focus driving voltage at a preset predetermined position A on the inner circumferential side) and the outer circumferential side focus driving voltage (the outer circumferential side focus driving voltage at a preset predetermined position B on the outer circumferential side) temporarily stored in the RAM 25 using following expression:

b=(Outer circumferential side focus driving voltage (V)−Inner circumferential side focus driving voltage (V))×Focus actuator sensitivity (m/V).

In a step S7, the CPU 24 calculates the tilt θ of the optical disc 2 based on the calculated distance a between A and B (distance of movement) and the difference b in height of the focus position by the formula (tan θ=b/a).

In a step S8, the CPU 24 determines whether the calculated tilt θ of the optical disc 2 is larger than a preset predetermined reference value, or not.

Herein, the allowance (magnitude of the tilt margin range) of the tilt of a disc varies according to the type (e.g., CD, DVD, or HD-DVD) of the optical disc 2. Namely, in general, the allowance decreases in the order of CD>DVD>HD-DVD. For this reason, the predetermined reference values are preset at different values according to the type of the optical disc 2. For example, for a CD, the predetermined reference value is preset, for example, at 1 degree; for a DVD, the predetermined reference value is preset, for example, at 0.63 degree; and for a HD-DVD, the predetermined reference value is preset, for example, at 0.2 degree. Incidentally, the preset predetermined reference value may be appropriately changed.

For example, when the optical disc 2 is a DVD, in the determining processing of the step S8, it is determined whether or not the calculated tilt θ of the optical disc 2 is larger than 0.63 degree which is a preset predetermined reference value.

It is naturally understood that the determining may be made not based on the magnitude of the tilt θ but based on the value of tan θ (b/a).

When the tilt θ of the optical disc 2 calculated in the step S8 is determined as being larger than the preset predetermined reference value, in the step S9, the CPU 24 controls the optical pick-up 5, the signal processing circuit 14, and the tilt control circuit 22. Thus, the CPU 24 tilts the optical axis of the objective lens at an appropriate value to the tilt of the information recording side of the optical disc 2, thereby to correct the tilt θ of the optical disc 2. This can correct the tilt occurring in the optical disc 2. As a result, it is possible to suppress a relative increase in noise, an increase in jitter (the ratio of deviation from the regeneration clock when the data reproduction signal has been made into a binary form), or the like.

On the other hand, when the tilt θ of the optical disc 2 calculated in the step S8 is determined as being smaller than the preset predetermined reference value, in the step S10, the CPU 24 controls the optical pick-up 5, the signal processing circuit 14, and the tilt control circuit 22, and cancels the correction processing of the tilt (θ) of the optical disc 2.

Subsequently, the optical pick-up 5, the signal processing circuit 14, the tracking control circuit 16, the thread motor control circuit 17, and the like are controlled. Thus, the position of the beam spot (radius position) is shifted to the inner circumference side by performing a seek in the direction of radius of the optical disk 2.

In the embodiment of the invention, the tilt θ occurring in the optical disc 2 is calculated. It is determined whether the calculated tilt θ of the optical disc 2 is larger than a preset predetermined reference value, or not. When the calculated tilt θ of the optical disc 2 is determined as being larger than the preset predetermined reference value, the tilt θ occurring in the optical disc 2 is corrected. Whereas, when the calculated tilt θ of the optical disc 2 is determined as being smaller than the preset predetermined reference value, the correction processing for the tilt θ occurring in the optical disc 2 can be canceled. As a result of this, it is possible to prevent the useless correction of the tilt of the optical disc 2 according to the type (e.g., CD, DVD, or HD-DVD) of the optical disc 2 while suitably correcting the tilt of the optical disc 2. When the tilt θ of the optical disc 2 is a small tilt within the tilt margin range for each type, it is possible to prevent the tilt correction processing from being unnecessarily executed. As a result, it is possible to shorten the initial operation completion time until the completion of the initial operation.

For example, it is possible to shorten the initial operation completion time, which is generally required to be about 20 seconds, to about 15 seconds. This eliminates the necessity for a user to uselessly wait for a long time during the period until the completion of the initial operation.

Whereas, in recent years, a large number of poor quality products have occurred in manufactured optical discs 2. Thus, the correction processing corresponding to the tilt θ of each optical disc 2 is executed. As a result, it is possible to suitably correct the tilt of the optical disc 2.

Therefore, it is possible to improve the availability of the optical disc apparatus 1.

Incidentally, in the embodiment of the invention, after the completion of the initial operation to be executed before the recording processing or the reproducing processing in the optical disc apparatus 1, the tilt correction processing is executed. However, it is not necessary to wait until the completion of the initial operation when the calculation processing of the tilt θ of the optical disc 2 is not hindered thereby. It is also acceptable that the tilt correction processing is executed concurrently with the initial operation.

Further, the invention may be applied not only to a rewritable type optical disc 2 such as a CD-RW or a DVD±RW but also to a write-once type optical disc 2 capable of recording only once such as a CD-R or a DVD-R. Alternatively, the invention may be applied to a read-only optical disc 2 such as a DVD-ROM.

Incidentally, a series of the processings described in the embodiment of the invention can also be executed by software. However, it can also be executed by hardware.

Further, in the embodiment of the invention, for the steps of the flowchart, examples of the processing to be executed in time sequence in accordance with the order described were described. However, they include the processings to be executed in parallel, or individually even though they are not necessarily executed in time sequence.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a calculation unit that calculates a tilt of a disc;
a determining unit that determines whether or not the tilt of the disc calculated by the calculation unit is larger than a preset predetermined reference value; and
a correction unit that corrects the tilt of the disc calculated by the calculation unit.

2. The optical disc apparatus according to claim 1, wherein:
when the tilt of the disc calculated by the calculation unit is determined as being larger than the preset predetermined reference value by the determining unit, the correction unit corrects the tilt of the disc calculated by the calculation unit; and
when the tilt of the disc calculated by the calculation unit is determined as being smaller than the preset predetermined reference value by the determining unit, the correction unit cancels the correction processing of the tilt of the disc calculated by the calculation unit.

3. The optical disc apparatus according to claim 1,
wherein the preset predetermined reference value is set at a different value for each type of the disc.

4. An optical disc recording and reproducing method of an optical disc apparatus, comprising:
calculating a tilt of a disc;
determining whether or not the tilt of the disc is larger than a preset predetermined reference value; and
correcting the tilt of the disc.
